(19) United States
(12) Patent Application Publication
(10) Pub. No.: US 2010/0124728 A1
(43) Pub. Date: May 20, 2010

(54) DEVICE AND METHOD FOR IN CANAL GUTTA-PERCHA HEATING AND CONDENSATION

(76) Inventor: Harmeet Walia, Newberry, FL (US)

Correspondence Address: BOYLE FREDRICKSON S.C., 840 North Plankinton Avenue, MILWAUKEE, WI, 53203, US

(21) Appl. No.: 12/616,392

(22) Filed: Nov. 11, 2009

Related U.S. Application Data
(60) Provisional application No. 61/116,251, filed on Nov. 19, 2008.

(51) Int. Cl. A61C 5/04

(52) U.S. Cl. 433/32; 433/81; 433/224

(57) ABSTRACT

A device and method of forming a gutta-percha tooth canal obturation. The device includes an amount of gutta-percha that is supported by a thermally conductive core. The core and the gutta-percha are both positioned within a root canal. In canal heating of the core heats the gutta-percha proximate an application point thereby improving the ability to compact the gutta-percha to the shape of the root canal and achieve three dimensional obturation preventing reinfection of the canal.

### CROSS-REFERENCE TO RELATED APPLICATIONS

This application claims priority to U.S. Provisional Patent Application No. 61/116,251, filed on Nov. 18, 2008, the disclosure of which is expressly incorporated herein.

### BACKGROUND OF THE INVENTION

The present invention relates generally to dental repairs and, more particularly, to a device and method for heating gutta-percha within a root canal to improve the three dimensional obturation of the canal by the gutta-percha. More specifically, the present invention relates to a device and technique for the obturation phase of root canal treatment whereby gutta percha is heated within the confines of the root canal to provide a tight seal by getting three dimensional obturation.

Typical root canal repair generally includes accessing the root canal, preparation of the root canal, and filling or obturation of the canal with an amount of gutta-percha material. Commonly, the gutta-percha is cone shaped and is of sufficient length so as to generally correlate to the shape of the assessed root canal. Desired obturation of the canal requires compacting the gutta-percha into the space of the canal so as to reduce the possibility of reinfection of the root canal that has been cleaned and shaped and disinfected by hand/rotary instrumentation and the use of chemical irrigants and/or, in some cases, the use of medicaments. The obturation of the canal allows a fluid tight seal from the canal orifice to the apex so as to limit incidents of reinfection. Preferred condensation of the gutta-percha also eliminates any interstitial voids or cavities that may collect or accumulate fluids or materials or inflammatory foreign bodies or bacteria.

One method of gutta-percha obturation is commonly referred to as cold compaction or lateral condensation. During lateral condensation or cold compaction, one or more room temperature gutta-percha cones are compacted into the root canal. A substantial short fall of such an approach is the inability to attain a preferred degree of void free condensation of the gutta-percha within the root canal with the room temperature gutta-percha. Also the use of multiple cones offer multiple interfaces along which leakage can occur.

To overcome the shortfalls of lateral condensation or cold compaction, others have heated the gutta-percha thereby increasing the plasticity of the gutta-percha in an effort to achieve better compaction of the gutta-percha to the shape and contour of the root canal. Unfortunately, such approaches have their own respective drawbacks. One such approach externally heats the gutta-percha on a carrier prior to introducing the gutta-percha and the carrier to the root canal. The heated gutta-percha has a tendency to be undesirably stripped from the carrier as the carrier is introduced into the root canal. Also gutta-percha being a poor conductor of heat and electricity quickly loses its plasticity during the transfer process into the canal.

In an effort to overcome the undesired premature stripping of the gutta-percha from the carrier, other methods include introducing a heated tool or thermal carrier so as to provide continuous wave compaction to cold gutta-percha that has already been introduced into the root canal. However, such an approach creates a number of different temperature zones in the gutta-percha and/or non-uniform heating of the gutta-percha, especially in the apical segment of the gutta percha. Condensation of the non-uniformly heated gutta-percha results in obturations that can include voids or other undesired compaction inconsistencies. Commonly, the uneven heating of the gutta-percha yields an apex of the gutta-percha that is cooler and therefore less pliable than is desired. Accordingly, the undesired compaction inconsistencies are commonly located deep within the tooth proximate the root apex.

Attempting to overcome such obturation inconsistencies, others have created application or dispensing tools that heat the gutta-percha prior to introduction of the heated gutta-percha to the root canal. Although such injection techniques generally overcome the compaction inconsistencies discussed above, such an approach to root canal obturation presents other drawbacks. The externally heated gutta-percha must be heated to a temperature that is sufficient to maintain a relatively plastic condition of the gutta-percha throughout the process of forming the obturation. Unfortunately, gutta percha does not retain its plastic condition due to being a poor conductor of heat, and this shortens the working time in which the obturation has to be accomplished. Besides, when the gutta-percha is heated to such a temperature, the gutta-percha is also susceptible to extrusion through the canal apex during obturation. Said in another way, such an approach allows the heated and therefore more deformable gutta-percha to be undesirably extruded beyond the foramen of the canal and into the bone.

Therefore, in view of the above, there exists a need for a device and a method of delivering gutta-percha to a root canal that allows desired in-position heating of the gutta-percha and condensation of the heated gutta-percha without extruding the gutta-percha beyond the canal.

### SUMMARY OF THE INVENTION

The present invention provides a device and method of forming a gutta-percha tooth canal obturation that overcomes one or more of the drawbacks mentioned above. One aspect of the invention discloses a device that includes an amount of gutta-percha that is supported by a thermally conductive core. The core and the gutta-percha are both constructed to be positioned within a root canal. In canal heating of the core heats the gutta-percha proximate an application location thereby improving the ability to condense the gutta-percha to the shape of the root canal and thereby improving canal obturation.

Another aspect of the invention that is usable with one or more of the above aspects discloses a gutta-percha placement device having a gutta-percha cone that is shaped to extend longitudinally into a root canal. The device includes a core that is disposed within the gutta-percha and that is more thermally conductive than the gutta-percha so that heating of the core heats the gutta-percha. An energy source is connected to the core for heating the core when the core is disposed within a root canal.

A further aspect of the invention usable with one or more of the aspects above discloses a root canal obturating device that includes an amount of gutta-percha and a core that extends longitudinally into the gutta-percha and is formed of a body that is more thermally conductive than the gutta-percha. The device includes a condenser that is positioned about the core and has a work end that condenses the gutta-percha in a root canal as the core is removed from the gutta-percha and the root canal.

Another aspect of the invention usable with one or more of the aspects above discloses a method of obturating a root canal. An amount of gutta-percha is supported on a carrier body. The carrier body is heated within a canal to increase the pliability of at least a portion of the gutta-percha when both the gutta-percha and the carrier body are positioned in a root canal.

Another aspect of the invention includes terminating the core or carrier body short of protruding from an end or tip portion of the gutta-percha that is to be positioned proximate the apex of the foramen or apex of the canal. Such a construction prevents plasticizing of a tip portion of the gutta-percha to reduce or eliminate the potential of extruding the heated gutta-percha beyond the foramen of the canal.

Another aspect of the invention that is useable with one or more of the above aspects is forming the core or carrier body of material that is more thermally conductive than the gutta-percha and which is electrically conductive. In a preferred aspect, a variable output power source is electrically connected to the core so that, as an electrical signal is applied to the core, the temperature of the core increases and thereby increases the temperature of the gutta-percha.

A further aspect of the invention useable with one or more of the above aspects includes a condenser that is slidably positioned relative to the core or carrier body. The condenser includes a working tip that condenses the heated gutta-percha within the canal. During obturation, the core is withdrawn from the gutta-percha and the canal while the condenser condenses the heated gutta-percha within the canal. Preferably, the condenser extends circumferentially about the core. More preferably, a handle is attached to the condenser to improve the ability to manually manipulate the condenser with respect to the core.

These and various other features, aspects, and advantages of the present invention will be made apparent from the following descriptions of the drawings.

### BRIEF DESCRIPTION OF THE DRAWINGS

The drawings illustrate one preferred embodiment presently contemplated for carrying out the invention. In the drawings:

FIG. 1 is perspective view of a gutta-percha application device according to the present invention;

FIG. 2 is a schematic view of a power supply of the device shown in FIG. 1;

FIG. 3 is a detailed view of the heating and placement tool of the device shown in FIG. 1; and

FIG. 4 is a detailed view of the placement tool in use.

### DETAILED DESCRIPTION OF THE PREFERRED EMBODIMENT

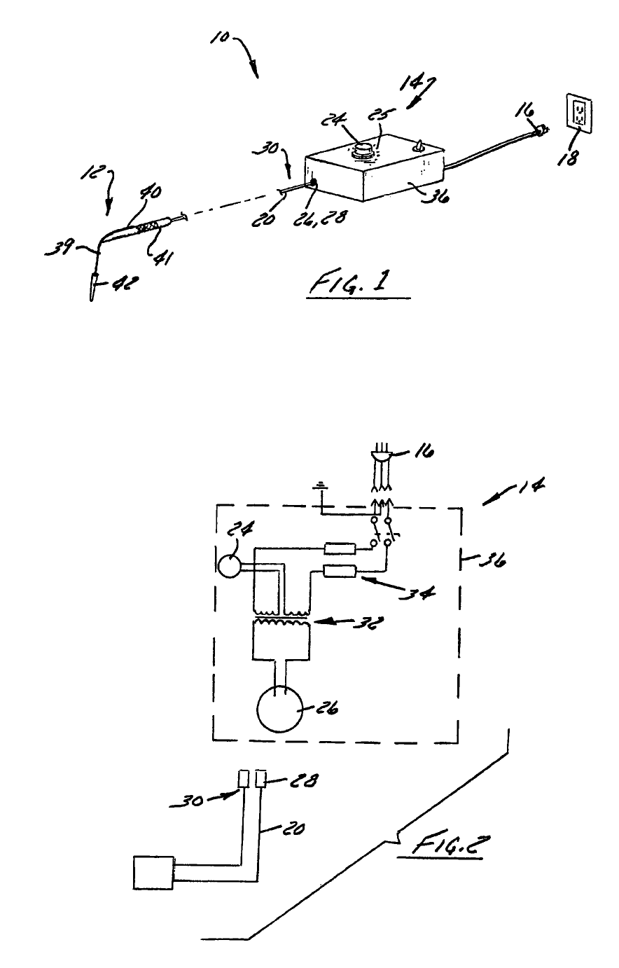

FIG. 1 shows a gutta-percha placement system 10 according to the present invention. System 10 includes a placement tool or device 12 that is connected to an energy source 14. Energy source 14 includes a plug 16 and is configured to be connected to energy grid indicated by outlet 18. Alternatively, energy source 14 could include a battery source or other wireless energy supply. A connection or cable 20 extends between energy source 14 and placement device 12. Referring to FIGS. 1 and 2, energy source 14 preferably includes an On/Off switch 22 and an input 24 that allows a user to select the amount of energy directed to placement device 12 via cable 20. Preferably, input 24 is provided as a variable output potentiometer or dial that includes an indicia 25 of the desired output level communicated to placement device 12. Preferably, for reasons described further below, the output indicia is provided in units of temperature.

Energy source 14 also preferably includes a connector, plug or socket 26 that removably receives a corresponding socket or plug 28 formed on a first end 30 of cable 20. Understandably, cable 20 could be directly connected to energy source 14 thereby omitting a severable connection between energy source 14 and placement device 12. A number of electrical components, including a switch 22, dial 24, a transformer 32, and one or more fuses 34 are positioned within a chassis or housing 36 of energy source 14. Whereas some of the electronics of energy source 14 can be manipulated by user outside of housing 36, such as switch 22, dial 24, and possibly fuses 34, other electronics, such as transformer 32, are preferably inaccessible to users of placement system 10 absent removing or otherwise accessing housing 36.

It is further envisioned that energy source 14 could be configured to include a feedback loop from placement tool. Such a feedback loop would be associated with confirming the generation of desired temperature with respect to placement device 12. It is further envisioned that energy source 14 could be configured to include a controller and switching arrangement associated with maintaining the desired temperature with respect to placement device 12.

It is further envisioned that energy source 14 and condenser 39 or conductor 40 could be configured to operate in energy communication modalities other than the electrical modality example disclosed herein. For instance, it is envisioned that energy source 14 could be configured to circulate a heated fluid to elevate the temperature of condenser 39 or could be configured to generate a magnetic field that repeatedly expands and collapses across a condenser or conductor that is thermally responsive to the magnetic field.

Referring to FIGS. 1, 2, and 3, an electrical signal generated by energy source 14 is communicated from energy source 14 to a condenser 39 that slidably cooperates with a core, carrier body, or conductor 40 of placement device 12. Condenser 39 is preferably supported by a handle 41 and extends from the handle in a direction that is conducive to placement of condenser 39 in an abated root canal. Conductor 40 extends into and supports an amount of canal filing material such as a synthetic resin-based polycaprolactone polymer, polyisoprene, or gutta-percha 42. Preferably, material 42 is radiographically opaque or radiographically dissimilar from dental structures, does not irritate periapical tissue, can be easily removed from the canal if necessary, and does not discolor adjacent dental structures. Although commonly referred to as gutta-percha, it is appreciated that such materials are commonly an amalgamation of materials that can include zinc oxide, metal salts, wax or resin, and gutta-percha. In one aspect of the invention, when material 42 is gutta-percha, material 42 can consist of about 50-80% zinc oxide, 1-17% heavy metal salts, 1-4% waxes and/or resins, and 15-20% actual gutta-percha.

Gutta-percha 42 preferably transitions from beta to alpha phase when heated to about 115 degrees Fahrenheit (46 degrees Celsius) and reaches an amorphous phase between about 130 degrees Fahrenheit (54 degrees Celsius) to about 140 degrees Fahrenheit (60 degrees Celsius). When cooled at a slow rate, the gutta-percha will recrystallize to the alpha phase but under normal conditions the material returns to beta phase. The softening point of gutta-percha has been found to be approximately 147 degrees Fahrenheit (64 degrees Celsius) whereat the phase transformation is considered for thermoplastic obturation techniques.

Conductor 40 includes a first or work end 44 that is positioned within gutta-percha 42 and a second end 46 that extends beyond gutta-percha 42 and which passes slidably through condenser 39. Gutta-percha 42 includes a canal apex end or distal tip 48 that is positioned beyond work end 44 of conductor 40. Said in another way, distal end or tip 48 of gutta-percha 42 is offset from the work end 44 of conductor 40. Preferably, tip 48 is offset between about 0.03937 inch or 1 mm and about 0.07874 inch or 2 mm from work end 44 of conductor 40. As described further below, such a construction prevents over plasticizing of the apical tip of the gutta-percha so as to prevent extrusion of the gutta-percha beyond a respective canal.

Conductor 40 and gutta-percha 42 are generally concentrically positioned with respect to a longitudinal axis of both conductor 40 and gutta-percha 42. Conductor 40 and gutta-percha 42 each have a generally elongated generally conical shape that is selected to fit preferably snuggly within an abated root canal. It is appreciated that gutta-percha 42 could be provided in a variety of external shapes, sizes, and configurations so as to allow selection of a gutta-percha and conductor pre-form that is best suited for obturation of a canal having a particular size, shape, and depth.

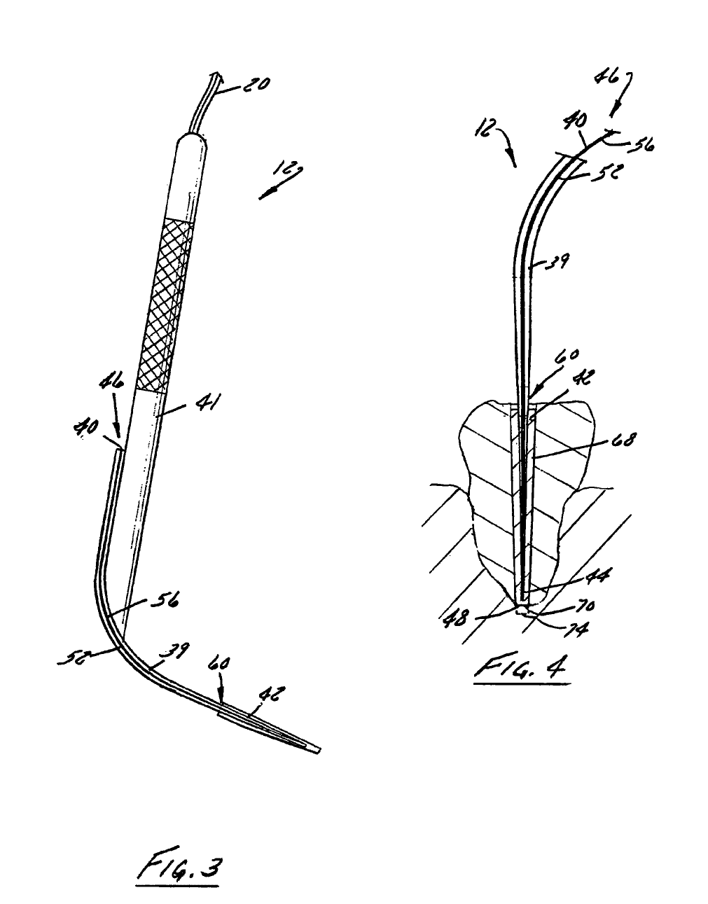

FIG. 3 is a detailed view of placement device 12. Condenser 39 includes an elongated body 50 that includes an opening or passage 52 formed therethrough. Condenser 39 is connected to handle 41 and is thermally responsive to the electrical signal communicated from energy source 14. Conductor 40 passes through passage 52 and is constructed from a material that has a degree of thermal transitivity sufficient to communicate the heat of condenser 39 along a body 56 of conductor 40. It is appreciated that altering the composition of conductor 40 and/or the composition of gutta-percha 42 will alter the thermal interaction between condenser 39, conductor 40, and gutta-percha 42. It is further appreciated that the composition of gutta-percha 42 can be altered so as to provide gutta-percha obturations that have different degrees of deformability at different temperatures. As such, it is appreciated that system 10 can be configured to satisfy a number of different conditions by altering the material of the gutta-percha and/or the material of the conductor.

Preferably, body 56 of conductor 40 is constructed to a metal material. Activation of condenser 39 heats the metal core and thereby causes softening of the gutta-percha that extends along a portion of the length of conductor 40 beyond condenser 39. It is readily appreciated that softening of the gutta-percha increases the plasticity or ability to deform the shape of the gutta-percha. It is further appreciated that the desired degree of softening of the gutta-percha can vary depending in part on various factors such as user preferences, composition of the gutta-percha, and/or abated canal geometry.

Still referring to FIG. 3, condenser 39 includes a distal or work end 60 that faces gutta-percha 42. Conductor 40 passes through condenser 39 and cooperates in close proximity with condenser 39 so that heating of condenser 39 results in heating of conductor 40 which in turn results in heating of gutta-percha 42. Preferably, gutta-percha 42 is heated such that it is pliable and can be readily deformed by interaction with condenser 39. After heating of gutta-percha 42, work end 60 of condenser 39 compacts the heated gutta-percha 42 in the canal and allows conductor 40 to be withdrawn from gutta-percha 42.

Referring to FIGS. 3 and 4, during canal obturation, an afflicted root canal 68 is vacated of any foreign and undesired fluids or materials. Such preparation can include the use of a variety of mechanical and chemical tools including one or more of syringes, slotted syringes, ultrasonic and apical negative pressure devices, chelators, antimicrobial agents, disodium EDTA, and/or sodium hypochlorite. After the removal of the undesired fluids and materials, an intended gutta-percha coated conductor 40, 42 is placed in the vacated canal and is assessed for fit and length in the root canal 68. Preferably, the fit of the gutta-percha coated conductor 40, 42 is confirmed with a digital radiograph or other fit measurement methodology. If the fit and length of the gutta-percha coated conductor 40, 42 is satisfactory with respect to the size and shape of the canal 68, that portion of conductor 40 that extends beyond gutta-percha 42 is fed through passage 52 of condenser 39 and forms a thermal connection between condenser 39 and gutta-percha 42.

When power is communicated to condenser 39, a portion of gutta-percha 42 is heated thereby softening, increasing the deformability, or increasing the plasticity of the portion of gutta-percha 42 that extends about conductor 40. The heated gutta-percha 42 can be conveniently and uniformly compacted with respect to the three dimensional shape of canal 68.

Because gutta-percha 42 is also a relatively poor thermal conductor, tip 48 of gutta-percha 42 remains less plastic than the portion of gutta-percha 42 that is positioned near body 56 of conductor 40. The less plastic tip portion 48 of gutta-percha 42 prevents the extrusion of gutta-percha 42 beyond foramen 70 of canal 68 even when condenser 39 is biased in a downward direction during formation of the obturation by gutta-percha 42. Accordingly, gutta-percha 42 is prevented from exiting canal 68 and entering any bone cavity 74 that may be located proximate the opening or foramen 70 of canal 68. As gutta-percha 42 is compacted by work end 60 of condenser 39, conductor 40 can be simultaneously withdrawn from both gutta-percha 42 and canal 68 leaving a well compacted gutta-percha obturation that extends to an approximate middle third of the canal.

Accordingly, system 10 allows in-place or in canal heating of gutta-percha 42 in a manner that avoids heating of the apex or distal tip of the gutta-percha. Preferably, the temperature of the lowermost approximately 0.03937 inch or 1 mm of tip 48 of gutta-percha 42 is left unheated during energization of condenser 39 thereby reducing and preferably preventing incidence of extrusion of the gutta-percha beyond the foramen of the canal. System 10 provides a Heated Obturation by Tracking or “HOT” obturation technique that is different than known lateral condensation, vertical condensation, continuous wave and injection obturation techniques. The relatively uniform in-place heating of gutta-percha 42, with the exception of the tip portion of the gutta-percha 42, and the cooperation of condenser 39 with conductor 40 allows more efficient and repeatable generation of substantially uniform and well compacted obturation of the root canal.

Therefore, one embodiment of the invention includes a gutta-percha placement device having a gutta-percha cone that is shaped to extend longitudinally into a root canal. The device has a core that is disposed within the gutta-percha and that is more thermally conductive than the gutta-percha so that heating of the core heats the gutta-percha. An energy source is connected to the core for heating the core when the core is disposed within a root canal.

Another embodiment of the invention that is usable with one or more of the aspects of the above embodiment includes a root canal obturating device that has a core that extends longitudinally into an amount of gutta-percha. The core is formed of a body that is more thermally conductive than the gutta-percha. The device includes a condenser that is positioned about the core and has a work end that condenses the gutta-percha in a root canal as the core is removed from both the gutta-percha and the root canal.

Another further embodiment of the invention that is useable with one or more of the features of the above embodiments includes a method of obturating a root canal. The method includes supporting an amount of gutta-percha on a carrier body and heating the carrier body when both the gutta-percha and the carrier body are positioned in a root canal to increase the pliability of at least a portion of the gutta-percha.

Understandably, the present invention has been described above in terms of the preferred embodiment. It is recognized that various alternatives and modifications may be made to these embodiments which are within the scope of the appending claims.

What is claimed is:

1. A gutta-percha placement device comprising:
a gutta-percha cone that is shaped to extend longitudinally into a root canal; and
a core disposed within the gutta-percha and being more thermally conductive than the gutta-percha so that heating of the core heats the gutta-percha; and
an energy source that is thermally connected to the core for heating the core when the core is disposed within a root canal.

2. The device of claim 1 wherein the gutta-percha includes a tip portion adjacent a distal end of the core that is not plasticized by heating of the core.

3. The device of claim 2 wherein the tip portion of the gutta-percha prevents the gutta-percha from passing beyond an apex of the root canal.

4. The device of claim 1 wherein the core is more thermally conductive than the gutta-percha.

5. The device of claim 4 wherein the energy source is a power supply that is electrically connected to a condenser that is thermally connected to the core and which, when energized, increases the temperature of the core.

6. The device of claim 1 further comprising a condenser that is slidable along the core for condensing the gutta-percha.

7. The device of claim 7 wherein the condenser extends circumferentially about a portion of the core that extends beyond the gutta-percha.

8. The device of claim 1 further comprising a handle attached to the condenser.

9. A root canal obturating device comprising:
an amount of gutta-percha;
a core that extends longitudinally into the gutta-percha and that is formed of a material that is more thermally conductive than the gutta-percha; and
a condenser positioned about the core and having a work end that condenses the gutta-percha in a root canal as the core is removed from both the gutta-percha and the root canal.

10. The device of claim 9 further comprising a power source that is connected to the condenser and which communicates energy to the condenser to elevate the temperature of the condenser and wherein a portion of the thermal energy of the condenser is communicated to the core.

11. The device of claim 10 further comprising an input configured to alter the electrical power communicated to the core.

12. The device of claim 9 wherein the core includes a distal end that is offset from an apex end of the gutta-percha.

13. The device of claim 9 further comprising a handle attached to the condenser.

14. The device of claim 9 wherein the core extends beyond both ends of the condenser and the gutta-percha extends beyond one end of the core.

15. A method of obturating a root canal comprising:
supporting an amount of gutta-percha on a carrier body; and
heating the carrier body to increase the pliability of at least a portion of the gutta-percha when both the gutta-percha and the carrier body are positioned in a root canal.

16. The method of claim 15 wherein heating the carrier body further comprises communicating an electrical signal to a condenser that is positioned about the carrier body.

17. The method of claim 16 further comprising manipulating the pliability of the gutta-percha by adjusting the electrical signal communicated to the condenser.

18. The method of claim 15 wherein supporting an amount of gutta-percha on a carrier body includes extending a portion of the gutta-percha beyond a distal end of the carrier body.

19. The method of claim 15 further comprising extracting the carrier body from the gutta-percha while retracting the carrier body from the root canal and condensing the gutta-percha relative to the root canal.

20. The method of claim 15 further comprising heating a majority of the gutta-percha to a first temperature that is above a temperature of a tip portion of the gutta-percha.
